(19) United States
(12) Patent Application Publication
(10) Pub. No.: US 2006/0246960 A1
(43) Pub. Date: Nov. 2, 2006

(54) Nametones

(76) Inventors: McClifton Taft Magee JR., Bakersfield, CA (US); McClifton Taft Magee SR., Huntington Beach, CA (US)

Correspondence Address: McClifton T. Magee, 8402 Northport Dr., Huntington Beach, CA, 92646, US

(21) Appl. No.: 11/119,445

(22) Filed: May 2, 2005

(51) Int. Cl. H04M 1/00; H04B 1/38

(52) U.S. Cl. 455/567

(57) ABSTRACT

We professionally record original or published songs and enter someone's name or alias or nickname etc. where a key word or phrase existed before. Editing our recording in such a way that we can insert the name, and accompanying music, of someone so as to personalize the cell phone ringer does this. For example, take the 1960's hit ‘My Girl” by the Temptations: Instead of “I guess you say, what can make me feel this way . . . “My Girl”; we would replace “My Girl” with “Mary” or “Johnny” or what have you.

A name tone is a personalization of the classic ring tone. We record original or published songs and enter a customer's name or alias or nickname where a key word or phrase exited before. For example, take the 1960's hit ‘My Girl” by the Temptations: Instead of “I guess you say, what can make me feel this way . . . ”My Girl”; we would replace “My Girl” with “Mary” or “Johnny” or what have you.

These songs are then made available as cell phone ringers via the Internet or other distribution methods.

1. We claim the personalizing of songs that will be used as cell phone ringers as our intellectual property.
We call them “name tones”
